(19) United States
(12) Patent Application Publication
(10) Pub. No.: US 2010/0154852 A1
(43) Pub. Date: Jun. 24, 2010

(54) Folding Igloo Sleeping Bag

(76) Inventor: Toan Trieu, Anaheim, CA (US)

Correspondence Address: STETINA BRUNDA GARRED & BRUCKER, 75 ENTERPRISE, SUITE 250, ALISO VIEJO, CA, 92656, US

(21) Appl. No.: 12/490,152

(22) Filed: Jun. 23, 2009

Related U.S. Application Data
(60) Provisional application No. 61/076,106, filed on Jun. 26, 2008.

(51) Int. Cl. E04H 15/02; A47G 9/08; A47G 9/06; E04H 15/44; E04H 15/36; B31B 1/26

(52) U.S. Cl. 135/96; 135/128; 493/405

(57) ABSTRACT

An easy to carry, transport, fold/unfold and store sleeping apparatus is disclosed herein. The apparatus comprises a collapsible dome attached to a sleeping compartment. The sleeping compartment may also be attached to a sleeping mat (e.g., air inflatable sleeping mat) for insulating the user from the cold ground and rocks. The sleeping mat may be attached to a rigid panel for providing a generally flat surface for the user to sleep upon. The sleeping compartment, sleeping mat and rigid panels may be folded around the collapsed dome to collapse the sleeping apparatus for storage and transport. Sides of the folded apparatus may be zippered to prevent entrance of undesirable material (e.g., rodents, dust, etc.) during storage and transport of the apparatus.

### CROSS-REFERENCE TO RELATED APPLICATIONS

This application claims priority to U.S. Provisional Patent Application Ser. No. 61/076,106, filed on Jun. 26, 2008, the entire contents of which are incorporated herein by reference.

### STATEMENT RE: FEDERALLY SPONSORED RESEARCH/DEVELOPMENT

Not Applicable

### BACKGROUND

The device disclosed herein relates to a combination sleeping bag and dome that is easy to transport and store but also convenient to unfold for use and collapse for storage and transport.

Throughout the United States, there are numerous areas where people can go on car camping trips. These car camping trips are essentially a drive to a scenic area with campsites. No extensive hiking from the parking lot to the campsite is required. Rather, the distance between the parking space and the tent site is generally immediately adjacent to each other or within a short walking distance. However, the user must walk back and forth to unload his/her gear in multiple trips.

The gear may comprise a tent, sleeping bag, sleeping mat and other miscellaneous items (e.g., food, change of clothing etc.). The tent typically comprises a plurality of bendable poles that may be secured to the upper surface of the tent to raise the upper surface and provide an inner cavity within the tent for the user or users to sleep or rest. After pitching the tent, the user lays his/her sleeping bag within the tent and a sleeping mat to protect the user from the cold ground and also to provide a comfortable sleeping surface. While the user is sleeping in the sleeping bag and on the mat, the sleeping bag may shift off of the sleeping mat thereby interrupting the user's sleeping experience. Set up of prior art tents, sleeping bags and mats are cumbersome to transport, store and set up.

At the end of the camping trip, the user must then fold up the sleeping mat, sleeping bag and tent which will then be transported back to the car and stored for later use.

Unfortunately, prior art sleeping bags prior art sleeping bags, tents and mats are difficult to pack up. The air from the mat must be removed. Also, the poles from the tent must be removed and folded. The tent itself must also be folded and stored in a bag. The sleeping bag must be rolled up for later use. Each of these items must then be carried back to the car for transport. Also, these items all have unusual shapes such that they cannot be stacked upon each other for convenient storage.

### BRIEF SUMMARY

The folding igloo sleeping bag addresses the needs discussed above, discussed below and those that are known in the art.

The folding igloo sleeping bag is traversable between a collapsed position in which the folding igloo sleeping bag may be stored in a convenient compact manner or carried with handles or backpack straps. During use, the user may easily traverse the folded igloo sleeping bag from the collapsed configuration to the unfolded position. The folding igloo sleeping bag may be traversed to the unfolded position from the collapsed position in a quick and efficient manner. In particular, from the collapsed position, the user unzips side flaps of the collapsed folding igloo sleeping bag. Straps are then detached and a plurality of mats are unfolded to a flat laid out position. The mats provide the sleeping cushion upon which the user will rest. Once the mats are laid in the flat position on the ground, the user may erect a dome when desired. The dome may comprise a plurality of support members which support a mesh material and waterproof material selectively deployable depending on the user's needs.

The mat may be a compressible foam pad that may be inflated/deflated, inflated foam pad, or an air inflated pad to insulate the user from the ground and/or provide a soft cushion upon which the user may sleep upon.

To traverse the unfolded folding igloo sleeping bag to the collapsed position, air may be removed from the mats (if needed) by opening a valve, squeegeeing out the air then closing the valve. The mats are folded around the support members of the dome to form a box configuration. Straps attached to the mats are used to hold the mats in the box configuration during storage and transport. Side flaps are then zippered or otherwise secured to prevent undesirable material such as rodents, dust, etc. from entering the collapsed folding igloo sleeping bag during storage and/or transport. Rigid members may be attached to the bottom side of each of the mats such that the folding igloo sleeping bag may maintain a box configuration when traversed to the collapsed position.

The sleeping bag is secured on top of the mats and stored within the box configuration when not in use. The dome is also stored within the box configuration. As such, the sleeping bag, dome and sleeping mat may all comprise a unitary structure which integrally and conveniently unfolds and collapses as a unit.

When the folding igloo sleeping bag is traversed to the collapsed position, the collapsed folding igloo sleeping bag may be easily carried or transported via handles or backpack straps.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a deployed folding igloo sleeping bag;

FIG. 2 is a side view of the folding igloo sleeping bag shown in FIG. 1 in a collapsed configuration;

FIG. 3 is a perspective view of a frame of the folding igloo sleeping bag;

FIG. 4 is a cross sectional view of the folding igloo sleeping bag shown in FIG. 1;

FIG. 4A is an enlarged view of a first section of a dome portion shown in FIG. 4; and

FIG. 4B is an enlarged view of a second section of the dome portion shown in FIG. 4.

### DETAILED DESCRIPTION

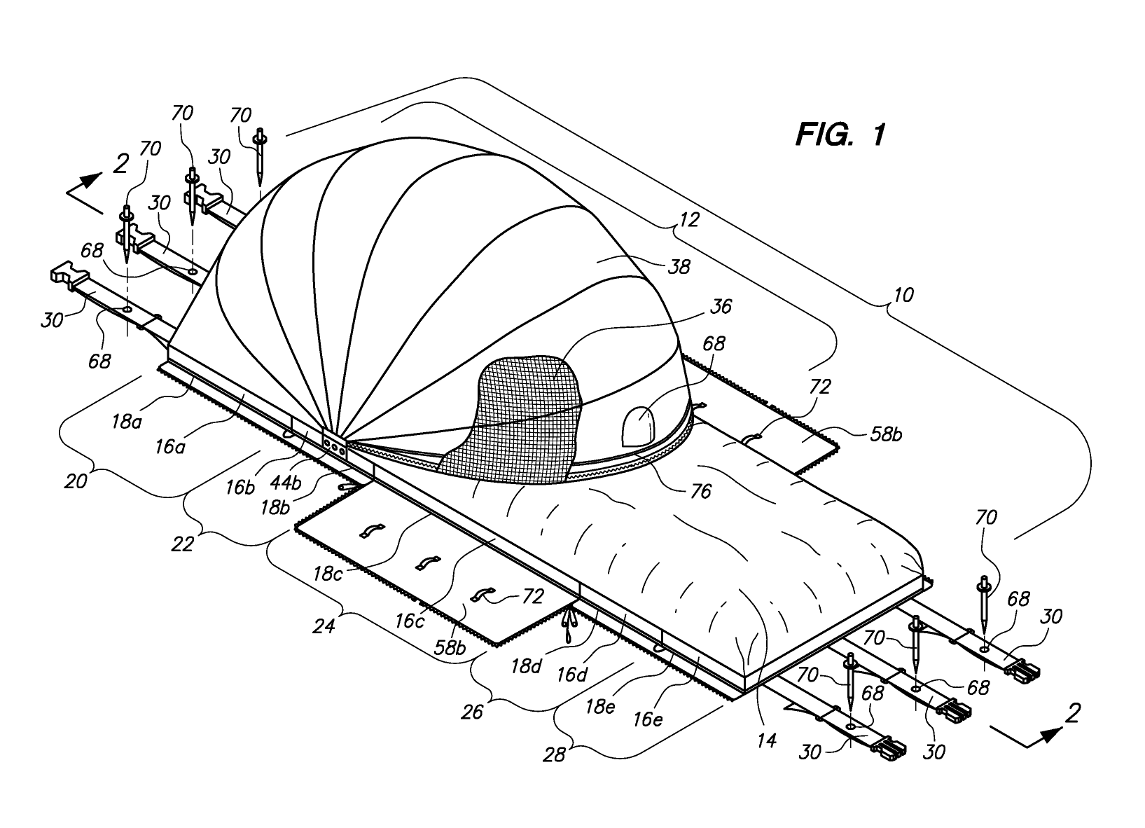

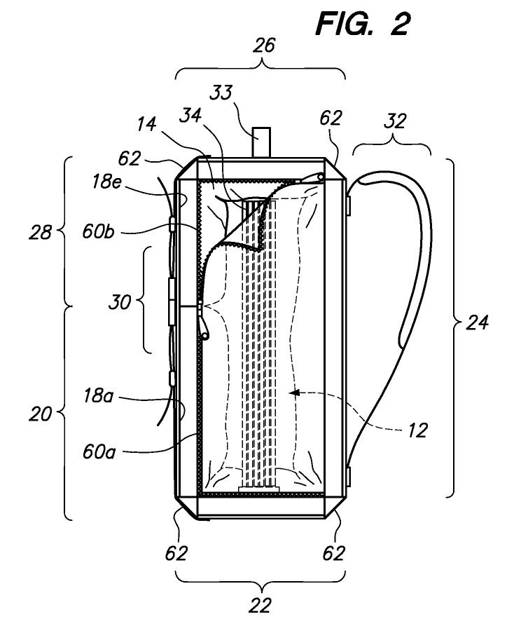

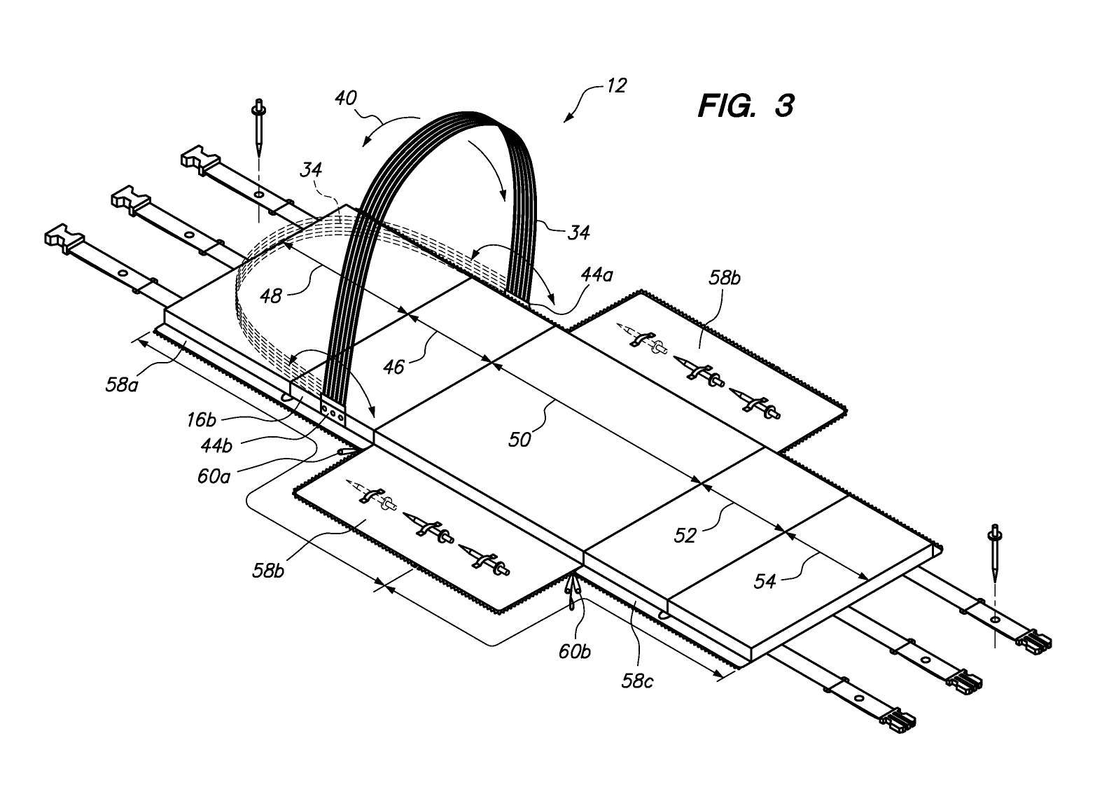

Referring now to FIG. 1, a folding igloo sleeping bag 10 is shown. The folding igloo sleeping bag 10 may have a dome portion 12 and a sleeping bag 14 disposed on top of a mat 16. The mat 16 may be divided into a plurality of sections 16a, b, c, d, e and have a generally rigid backing 18a, b, c, d, e. The first section 20 may be hinged to the second section 22. Likewise, the second section 22 may be hinged to the third section 24. The third section 24 may be hinged to the fourth section 26. The fourth section 26 may be hinged to the fifth section 28. The dome section 12 is also collapsible, as shown in FIG. 3. To fold the folding igloo sleeping bag 10, the first section 20 and the third section 24 are raised to the vertical position, as shown in FIG. 2. By this action, the dome portion 12 is also traversed to the collapsed position, as shown in FIG. 2. The fourth and fifth sections 26, 28 are folded above the collapsed dome portion 12. The fifth section 28 is then secured to the first section 20 with at least one set of straps 30 (e.g., buckles, snaps, hooks and loops, etc.). The folding igloo sleeping bag 10 when in the folded position (see FIG. 2) is in a compact and easy to carry state. When the folding igloo sleeping bag 10 is folded, a user may carry the folding igloo sleeping 10 with the provided backpack straps 32 or by hand carrying the folded folding igloo sleeping bag 10 with handles 33. For long term storage of the folding igloo sleeping bag 10, the folding igloo sleeping bag 10 is traversed to the folded configuration (see FIG. 2) then the sides may be zippered to prevent the entrance of any undesirable material (e.g., bugs, rodents, dust, etc.). The folding igloo sleeping bag 10 discussed herein provides an easy to pack, unpack and store device. Since the collapsed folding igloo sleeping bag 10 has a square configuration as shown in FIG. 2, the collapsed folding igloo sleeping bag 10 may be conveniently stacked upon each other or other objects.

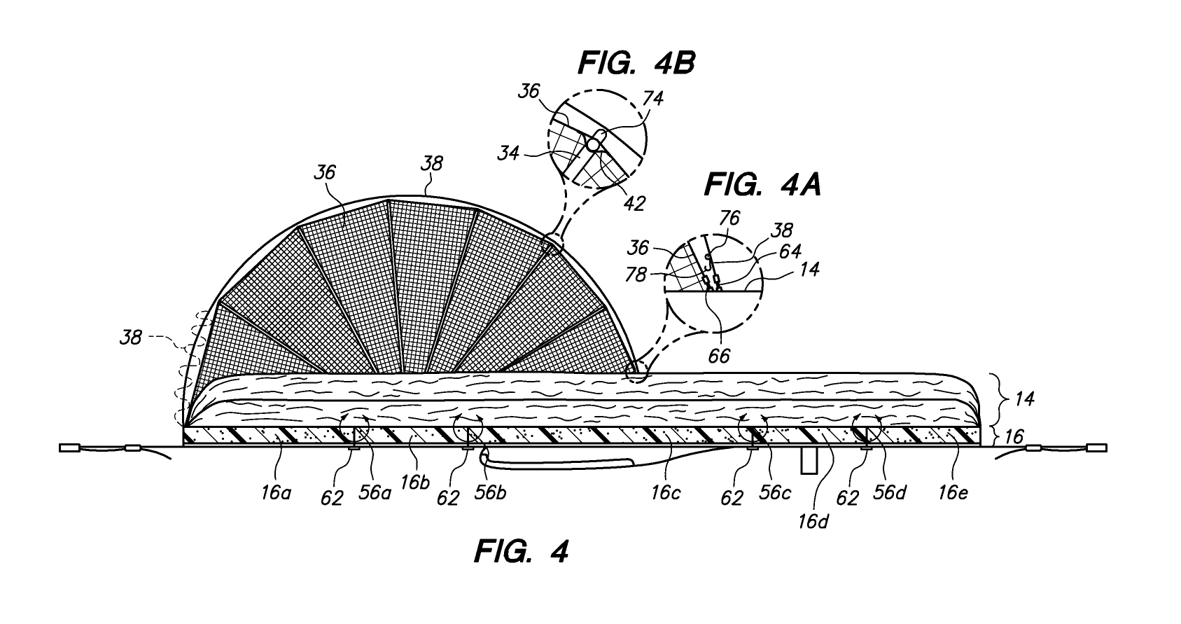

Referring now to FIG. 3, the dome portion 12 may comprise a plurality of support members 34. The support members 34 may be elongate fiberglass tubes that can be bent into the U-shaped configuration shown in FIG. 3. Alternatively, the support members 34 may alternatively be pre shaped into the U-shaped configuration. The support members 34 provide the basic support for a mesh material 36 and a waterproof material 38 (see FIG. 1) to provide a cavity within the folding igloo sleeping bag 10 such that a person may have a convenient area for his/her head and arms, reading a book, sleeping without feeling claustrophobic, etc. This is illustrated in FIG. 4. The support members 34 may be pushed rearward in the direction of arrow 40 shown in FIG. 3. In this manner, the person may retract the dome portion 12 such that while the person is sleeping in the sleeping bag 14, the person may view the stars above or his/her surroundings. The dome portion 12 may also be traversed to an erected position as shown in FIGS. 1 and 4. The waterproof material 38 may be extended over the entire mesh material 36 or pulled back to allow the person to be protected from bugs and other unwanted animals by deployment of the mesh material 36 but yet enjoy the fresh air and environment by pulling back the waterproof material 38. The hidden lines 38 shown in FIG. 4 illustrate the waterproof material 38 fully pulled back or open. When raining, the waterproof material 38 may be deployed as shown in solid lines in FIGS. 1 and 4 to prevent the person from getting wet. The waterproof material 38 may be zippered to the exterior surface of the sleeping bag 14, as shown in FIG. 4A. Also, the mesh material 36 may be zippered to the exterior surface of the sleeping bag 14, as shown in FIG. 4A.

It is also contemplated that the waterproof material 38 may be left open at various intermediate positions between the fully pulled back position shown in hidden lines in FIG. 4 and the fully closed position shown in solid lines in FIG. 4. In particular, a plurality of loops 74 (see FIG. 4B) may be attached to the mesh material 36. The loops 74 may be sewn the mesh material 36 adjacent the support members 34 or attached directly to the support members 34 by sewing, gluing or other attachment methods at various intervals. The waterproof material 38 may have a support member 76 (see FIGS. 1 and 4) attached to its distal end portion. Referring now to FIG. 4, the support member 76 may have a hook 78 that can be removeably attachable to any one of the loops 74. In this manner, the user can attach the hook 78 to the loop 74 such that the waterproof material 38 is ¼ open, ½ open, ¾ open, etc. or open at other intervals. Although the loops 74 are described as being attached adjacent the support members 34, it is contemplated that the loops 74 may be attached at any positions on the mesh material 36. It is also contemplated that the distal end portion of the water proof material 38 may be removably attachable to the mesh material 36 at various intervals through other attachment mechanisms. By way of example and not limitation, a first part of the attachment mechanism (hooks and loops, snaps, buttons, etc.) is attached to the mesh material at various intervals. A second part of the attachment mechanism (hooks and loops, snaps, buttons, etc.) may be attached to the distal end portion of the waterproof material 38. The second part of the attachment mechanism may be selectively attached to any one of the first part attached to the mesh material 36 to partially open the waterproof material 38.

The waterproof material 38 may be secured to the brackets 44a, b (see FIGS. 1 and 3) such that the waterproof material 38 may pivot about such bracket 44a, b. Alternatively, waterproof material 38 may merely be draped over the mesh material 36 and the support members 34 and pulled off when not in use.

Referring now to FIG. 4B, the mesh material 36 may be secured to the support member 34. By way of example and not limitation, a strap 42 may be secured around the support member 34 by hooks and loops. In this manner, only selected support members 34 may be attached to the mesh material 36. Alternatively, the support members 34 may be fed through loops formed by strap 42 that may be sown to the mesh material 36 on both sides.

Referring now to FIG. 3, the support members 34 may be rotated about bracket 44a, b. They may be removably attachable to the mat 16b by means of snaps, hooks and loops, or other removable attachable systems that are known in the art. Preferably, the width of the support members 34 and the brackets 44a, b when in the vertical position shown in FIG. 3 is narrower than a length 46 of the mat 16b. This allows room for the sleeping bag 14 to wrap around the support members 34 as shown in FIG. 2. Additionally, a height of the support members 34 is preferably shorter than a length 50 of the third section 24 to allow room for the sleeping bag 14 to wrap over the support members 34, as shown in FIG. 2. The length 48, 50, 52, and 54 (see FIG. 3) of mats 16a, b, c, d, e (see FIG. 1) are sized to form a generally rectangular configuration as shown in FIG. 2 when the folding igloo sleeping bag 10 is traversed to the folded configuration.

Referring now to FIG. 4, the mats 16a, b, c, d, e hinge about each other at hinge points 56a, b, c, d. The hinge points 56a, b, c, d are shown as being on the upper side of the mat 16. However, the hinge point may be anywhere at that general vicinity as long as the mats 16a, b, c, d, e are able to rotate with respect to each other. The mat 16 may be air inflatable with a compressible sponge disposed therein. When deploying the folding igloo sleeping bag 10, the air inflatable mat 16 may have a valve which is opened. Each of the mats 16a, b, c, d, e may be fluidically connected to each other or isolated from each other. In either instance, one or all of the mats 16 may have a valve which may be opened when deploying the folding igloo sleeping bag 10. Upon opening the valve, air is introduced into the mat 16 or mats 16a, b, c, d, e. The sponge expands and draws air into the mat 16. When the appropriate amount of air is introduced into the mat 16, the valve is then closed to provide a cushion and insulate the user from the ground. To fold the folding igloo sleeping bag 10, the valve may be opened and air pushed out of the mat 16 either by squeegeeing the mat then closing the valve or other means known in the art. This allows enough room for the mat 16 and sleeping bag 14 to fold around the support members 34, as shown in FIG. 2. Alternatively, the mats 16 and the support members 34 may be sized and configured such that the mats 16 and the sleeping bag 14 may fold around the support members 34 even if the air within the mats 16 is not pushed out of the mat 16. Alternatively, it is contemplated that the mat 16 may be an air pad without foam or a foam pad.

Referring now to FIG. 3, flaps 58a, b, c may be attached to opposed sides of the mat 16a-e. These flaps 58a, b, c may have two sets of zippers 60a and 60b. As shown in FIG. 2, the zippers may be zipped to close the sides of the folding igloo sleeping bag 10 for storage or transport.

The rigid members 18a, b, c, d, e may be individually attached to the mats 16a, b, c, d, e, respectively. The rigid members 18a-e may be attached to the underside of the mats 16a-e and cover a substantial area of the mat's underside. To further support the folding igloo sleeping bag 10, elastic members 62 (see FIG. 4) may be formed at the joints between rigid members 18a and b, 18b and c, 18c and d, and 18d and e. Upon folding the folding igloo sleeping bag 10, these elastic straps 62 stretch out to provide rigidity and support to the folded configuration of the folding igloo sleeping bag 10, as shown in FIG. 2. When deploying the folding igloo sleeping bag 10, the elastic straps contract to urge the folding igloo sleeping bag 10 to the flat laid out position, as shown in FIG. 1.

The closure straps 30 may be attached to rigid members 18a-e, as shown in FIG. 1.

From the deployed position shown in FIG. 1, to use the folding igloo sleeping bag 10, the zippers 64, 66 (see FIG. 4A) which attach the waterproof material 38 and the mesh material 36 to the exterior of the sleeping bag 14 may be unzippered. The user may pull back the support members 34, mesh material 36 and waterproof material 38 such that the user may get into the sleeping bag 14. Once the user is inside of the sleeping bag 14, the user may pull back the mesh material 36 along with the support members 34 and optionally with the mesh material 36, the user may pull back the waterproof material 38 to the deployed position shown in FIG. 1. With the mesh material 36 in the deployed position and the waterproof material 38 in the deployed position, the user may zipper the waterproof material 38 to the exterior of the sleeping bag 14 then zipper the mesh material 36 to the exterior of the sleeping bag 14. In this manner, the user is protected from outside animals as well as the weather elements. Fresh air may be introduced into the cavity through the air vent 68 (see FIG. 1). Once inside the folding igloo sleeping bag 10, the user is provided with a small but ample space to read, etc. Moreover, instead of pulling the waterproof material 38 over the mesh material 36, the waterproof material 38 may be left in the retracted position as shown by the hidden lines in FIG. 4. The user may view the environment through the mesh material 36 as well as receive an ample amount of fresh air throughout the night.

To exit the folding igloo sleeping bag 10, the user unzips the zipper of the mesh material 36 and the zipper 66 of the waterproof material 38, if deployed. The support members 34 and the mesh material 36 and optionally the waterproof material 38 is pulled back to provide space for the user to exit the folding igloo sleeping bag 10.

For storage purposes, the folding igloo sleeping bag 10 may be folded into the folded configuration as shown in FIG. 2. The first and third sections 20, 24 are raised to the vertical position. The fourth and fifth sections 26, 28 are folded over the support members 34. The straps 30 are attached to each other to hold the folding igloo sleeping bag 10 in the folded configuration. As can be seen in FIG. 2, the support members 34 provide space for the sleeping bag 14 thereabout such that the folding igloo sleeping bag 10 may be folded or conveniently folded into the folded configuration. To further reduce any size limitations, the mat 16 may be air inflatable. Air may be removed from the air inflatable mat 16 to make additional room, if needed. Alternatively, the mats 16 and the folding igloo sleeping bag 10 may be sized such that the air does not have to be removed when traversing the folding igloo sleeping bag to the folded or collapsed position. After the sections 20, 22, 24, 26 and 28 are folded upon each other as shown in FIG. 2, zippers may zip the flap 58b to the flaps 58a and c on both sides of the folded igloo sleeping bag 10. The user may conveniently carry the collapsed folding igloo sleeping bag with the backpack straps 32 or handles 33. Additionally, since the collapsed folding igloo sleeping bag 10 has a square configuration (see FIG. 2), the collapsed folding igloo sleeping bag 10 may be stacked on or under other objects for convenient storage. This provides a convenient easy to carry and store/transport igloo sleeping bag 10.

To deploy the folding igloo sleeping bag 10, the above described operation is reversed. Also, once the folding igloo sleeping bag 10 is traversed to the unfolded position, the straps 30 (see FIG. 1) may have a reinforced hole 68. Pegs 70 may be inserted into the reinforced holes 68 as shown in FIG. 1 to secure the folding igloo sleep bag 10 to the ground. The pegs 70 may have a flanged ring to retain the straps 30 to the ground when the pegs 70 are secured to the ground. When the pegs 70 are not being used, the pegs 70 may be stored in holders 72 attached to the flaps 58b.

It is contemplated that the folding igloo sleeping bag 10 may have a width sized and configured to fit a single person. However, it is also contemplated that the folding igloo sleeping bag 10 may be fabricated in a wider configuration such that two people or more people may fit within the folding igloo sleeping bag 10.

It is contemplated that the sleeping bag 14 may be replaced with a waterproof membrane or fabric. As a result, the collapsed folding igloo sleeping bag 10 may have a more compact configuration since the thickness of the sleeping bag 14 does not have to be accounted for when sizing the support members 34 and the lengths 48, 46, 50, 52 and 54. Rather, these lengths may be made shorter or the support members 34 may be made higher to provide a more spacious inner cavity of the dome portion 12. During use, the user may sleep in a separate sleeping bag under the waterproof membrane or fabric to provide warmth to the user as the user is sleeping throughout the night.

The above description is given by way of example, and not limitation. Given the above disclosure, one skilled in the art could devise variations that are within the scope and spirit of the invention disclosed herein, including various ways of closing the flaps 58a, b, c such as through snaps and/or hooks and loops. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An easy set up and tear down sleeping apparatus, the apparatus comprising:
a sleeping compartment defining a foot portion and a head portion, the head portion defining a left side and a right side, the compartment being traversable between an unfolded position and a folded position;
a dome disposed at the head portion of the compartment and traversable between an erected position and a collapsed position, the dome comprising:
a plurality of frame members extending between the left side and the right side of the sleeping compartment and generally above the head portion of the compartment when the compartment is in the unfolded position and the dome is traversed to the erected position;
a net disposed over the plurality of frame members, the net defining an outer periphery having a first portion attached to the compartment and a second portion removably attachable to the compartment so a person may enter and exit the sleeping compartment;
wherein the dome is traversed to the collapsed position and the sleeping compartment is wrapped around the collapsed dome when the sleeping compartment is traversed to the folded position for conveniently tearing down the sleeping compartment, and the sleeping compartment is unwrapped from around the dome for conveniently setting up the sleeping apparatus.

2. The sleeping apparatus of claim 1 further comprising a plurality of rigid panels attached to a bottom side of the sleeping compartment for providing a smooth comfortable surface to sleep on when the person is lying down in the sleeping compartment, the plurality of rigid panels forming a box configuration when the sleeping compartment is traversed to the folded position for stackably storing the sleeping apparatus.

3. The sleeping apparatus of claim 2 further comprising a locking device for maintaining the sleeping apparatus in the box configuration during storage, the locking device comprising:
a first strap attached to one of the plurality of rigid panels;
a second strap attached to a different one of the plurality of rigid panels;
a first part of a male/female clip adjustably positionable secured to the first strap;
a second part of the male/female clip attached to the second strap, the second part being removably attachable to the first part of the male/female clip.

4. The sleeping apparatus of claim 1 further comprising a handle disposed on an exterior side of the sleeping compartment for easy transportation of the sleeping apparatus.

5. The sleeping apparatus of claim 1 further comprising a back pack strap disposed on an exterior side of the sleeping compartment for easy transportation of the sleeping apparatus.

6. The sleeping apparatus of claim 1 further comprising a plurality of mat sections attached to an underside of the sleeping compartment wherein the plurality of mat sections are hinged to each other and fold around the dome into a box configuration.

7. The sleeping apparatus of claim 6 further comprising rigid panels attached to an underside of the mat sections for forming a box configuration when the sleeping compartment is traversed to the folded position for stackable storage of the sleeping apparatus.

8. The sleeping apparatus of claim 1 wherein the sleeping compartment is a waterproof membrane or an insulated sleeping bag.

9. A method of collapsing a sleeping apparatus, the method comprising the steps of:
collapsing a plurality of frame members;
folding a sleeping compartment around the collapsed plurality of frame members;
locking the collapsed sleeping apparatus to maintain the frame members in the collapsed position and the sleeping compartment in the folded position for storage and transportation.

10. The method of claim 9 wherein the folding step includes the step of removing air from one or more mat sections.

11. The method of claim 9 wherein the folding step further includes the steps of:
rotating mat sections attached to the sleeping compartment around the collapsed plurality of frame members.

12. The method of claim 9 further comprising the step of closing the collapsed sleeping apparatus by zippering side panels to prevent entrance of undesirable material.
